(19) United States
(12) Patent Application Publication
(10) Pub. No.: US 2009/0162479 A1
(43) Pub. Date: Jun. 25, 2009

(54) PROCESS FOR PRODUCING SOY SAUCE HAVING REDUCED BUSHO-SHU

(75) Inventors: Akinori Nakatoh, Chiba (JP); Tsutomu Sasaki, Chiba (JP); Tomohiro Maeda, Chiba (JP); Takeshi Higuchi, Chiba (JP); Ryohei Tsuji, Chiba (JP); Nobutake Nunomura, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kikkoman Corporation, Noda-shi (JP)

(21) Appl. No.: 12/065,192

(22) PCT Filed: Aug. 31, 2005
(86) PCT No.: PCT/JP2005/015925

§ 371 Date: Feb. 28, 2008

(51) Int. Cl. A23L 1/238; A23L 1/20

(52) U.S. Cl. 426/46; 426/589

(57) ABSTRACT

The present invention relates to a process for producing a soy sauce koji having a reduced Busho-shu which is one of the unpleasant smells of soy sauce, and a soy sauce koji having a reduced Busho-shu obtained by this production process. Specifically, the process for producing a soy sauce koji is characterized by using a combination of a koji mold having a high isobutyric acid productivity and another koji mold having a low isobutyric acid productivity. The present invention also relates to a process for producing a soy sauce having a reduced Busho-shu and a soy sauce obtained by this production process.

### TECHNICAL FIELD

The present invention relates to a process for producing a soy sauce koji having a reduced Busho-shu which is one of the unpleasant smells of soy sauce, and a soy sauce koji having a reduced Busho-shu obtained by this production process. The present invention also relates to a process for producing a soy sauce having a reduced Busho-shu and a soy sauce obtained by this production process.

### BACKGROUND ART

In the production of soy sauce, firstly steam-cooked soybeans (or defatted soybeans) and roasted and milled wheat in approximate quarters are mixed to obtain a raw material of soy sauce koji, which is then added and mixed with a seed koji mold belonging to the genus Aspergillus (such as Aspergillus oryzae and Aspergillus sojae). The mixture is cultured for 3 to 4 days under a controlled temperature in a koji-making room to obtain a soy sauce koji. Next, this soy sauce koji and a salt water are mixed to obtain a soy sauce moromi mash, which is then placed in a tank for incubation. This soy sauce moromi mash is occasionally stirred to effect fermentation and aging to obtain an aged moromi mash. This aged moromi mash is wrapped in a nylon filter cloth and press-filtered by a squeezer to obtain a raw soy sauce (a filtrate of aged mash). This raw soy sauce is subjected to pasteurization, clarification, and sediment-removal to obtain a soy sauce (Hakko Handobukku (Fermentation Handbook), edited by Shinrokuro TOCHIKURA et al., Kyoritsu Shuppan Co. Ltd, 2001, pp. 588-592).

Moreover, a soy sauce is produced by the action of many microorganisms such as koji molds (Aspergillus oryzae and Aspergillus sojae), salt tolerant lactic acid bacteria (Tetragenococcus halophilus), salt tolerant main fermentation yeast (Zygosaccharoinyces rouxii), and salt tolerant after-ripening yeast (Candida versatilis and Candida etchellsii) (Hakko Handobukku (Fermentation Handbook), edited by Shinrokuro TOCHIKURA et al., as mentioned above).

Incidentally, soy sauce aroma is very complex and delicately different depending on the formula of raw material, koji mold, management of koji-making, lactic acid bacterium and yeast related to fermentation, intensity of fermentation, and the like. It is also known that the taste is differently felt depending on this aroma (Nobuo SAITO, Jokyo, Vol. 89, No. 7, pp. 498-500 (1994)). As to this soy sauce aroma, the existence of aroma components which are said to be related to the palatability and the freshness, namely furanones such as 4-hydroxy-2(or 5)-ethyl-5(or 2)-methyl-3(2H)-furanone (hereunder, referred to as HEMF), alcohols such as 4-ethylguaiacol (4EG), 4-ethylphenol (4EP), methionol, isobutyl alcohol, and ethanol, esters such as ethyl acetate and ethyl lactate, phenols, and sulfur-containing compounds, and conversely the existence of components for Busho-shu (natto-like odor compounds) which are unfavorable for soy sauce aroma and greatly spoil the quality, namely isobutyric acid and isovaleric acid are known (Tadanobu NAKADAI, Shoyu no Kenkyu to Gijutsu (Research and Technology of Soy Sauce), Vol. 31, No. 4, pp. 223-233 (2005)).

Meanwhile, since soy sauce is a seasoning based on the umami taste of amino acid, it is important in the production of soy sauce to increase the production amount of amino acid and the production amount of glutamic acid by increasing the utilization rate of nitrogen. Therefore, it is very important in the production of soy sauce to breed, search, and use koji molds that are capable of yielding strong protease and glutaminase and capable of producing a highly digestible koji. Conventionally, by such reasons, it has been considered to produce a soy sauce koji (hereunder, also referred to as “koji-making”) by using a specific koji mold which secretes a strong protease for a soy sauce koji.

As mentioned above, a process for producing a soy sauce koji which produce large amounts of amino acid and glutamic acid so as to produce a soy sauce having an excellent aroma and umami taste, has been desired.

### DISCLOSURE OF THE INVENTION

In order to produce excellent soy sauce koji, koji molds which produce a strong protease and provide a highly digestible koji have been developed. However, the use of such koji molds involves a risk in which a high concentration of a component for Busho-shu which is one of the unpleasant smells of soy sauce, namely isobutyric acid, accumulates in the raw material of soy sauce koji after 20 to 30 hours from the start of koji-making. This component for Busho-shu is generally metabolized (degraded) during the koji-making and hardly remains in the incubated koji (de-koji). However, in some cases depending on the koji mold strain, this component may not be sufficiently metabolized during the koji-making and remains as it is in the incubated koji (de-koji), resulting in that the smell is subsequently transferred to soy sauce products and negatively affects the soy sauce quality, in particular the aroma thereof.

Therefore, it is an objective of the present invention to produce a soy sauce koji having a reduced Busho-shu which is one of the unpleasant smells of soy sauce, and a soy sauce koji having a reduced Busho-shu using the koji.

The inventors of the present invention have conducted intensive studies to solve the above problems. As a result, they have found that, in the koji-making by the inoculation of a koji mold having a high isobutyric acid productivity which belongs to the genus Aspergillus and a koji mold having a low isobutyric acid productivity which belongs to the genus Aspergillus into a same raw material of soy sauce koji, the koji mold having a low isobutyric acid productivity metabolizes isobutyric acid that has been produced and accumulated by the koji mold having a high isobutyric acid productivity, so as to provide a soy sauce koji having less Busho-shu. Also, they have found that the production of a soy sauce using this soy sauce koji provides a soy sauce having less Busho-shu. These findings have led to the completion of the present invention.

That is to say, the present invention relates to a process for producing a soy sauce koji having a reduced Busho-shu, wherein koji-making is performed by inoculating a seed koji mold belonging to the genus Aspergillus which produces a high concentration of isobutyric acid during the koji-making and a seed koji mold belonging to the genus Aspergillus which does not produce, or produces a low concentration of isobutyric acid during the koji-making, into a same raw material of soy sauce koji.

The koji mold belonging to the genus Aspergillus which produces a high concentration of isobutyric acid during koji-making is preferably a koji mold which produces isobutyric acid at a double amount or more after 24 or 30 hours from the start of koji-making, as compared with the amount of isobutyric acid produced after 20 hours from the start of the koji-making. For example, the koji mold belonging to the genus Aspergillus which produces a high concentration of isobutyric acid during koji-making is a koji mold which produces 40 ppm or more of isobutyric acid after 24 or 30 hours from the start of the koji-making, when koji-making is performed under the following condition (A):

### Koji-Making Condition (A):

26 g of defatted soybeans is sprayed with 135 W/W % water. 28 g of wheat is roasted and milled, and the resultant is mixed with the thus obtained soybeans. The mixture is then put into a 2 liter Fernbach flask, followed by sterilization under pressure and heating at 121° C. for 50 minutes. The resultant product is cooled down to a room temperature, and inoculated with 100 mg of bran seed koji. The flask is cotton-plugged and then is incubated in a thermostatic chamber at a room temperature of 30° C. to start koji-making. After 16 hours, the Fernbach flask is shaken so as to remove the heat generated in the koji (mixing process called “Teire”), and then is transferred into a thermostatic chamber at a room temperature of 25° C. After 8 hours, the “Teire” is performed again to remove the heat generated in the koji, and then is transferred into a thermostatic chamber at a room temperature of 20° C. The koji-making is performed for 42 hours in total to obtain a koji.

There is no limitation in the above koji mold belonging to the genus Aspergillus which produces a high concentration of isobutyric acid during koji-making, although Aspergillus sojae, and preferably Aspergillus sojae strain ATCC 46250, can be used.

On the other hand, the koji mold belonging to the genus Aspergillus which does not produce, or produces a low concentration of isobutyric acid during koji-making is preferably a koji mold which produces isobutyric acid at a reduced amount, or no isobutyric acid at all, after 24 or 30 hours from the start of koji-making, as compared with the amount of isobutyric acid produced after 20 hours from the start of the koji-making. For example, the koji mold belonging to the genus Aspergillus which does not produce, or produces a low concentration of isobutyric acid during koji-making is a koji mold which produces 20 ppm or less of isobutyric acid after 24 or 30 hours from the start of the koji-making, when a koji-making is performed under said condition (A).

There is no limitation in the above koji mold belonging to the genus Aspergillus which does not produce, or produces a low concentration of isobutyric acid during koji-making, although Aspergillus oryzae, and preferably Aspergillus oryzae strain ATCC 22787, can be used.

Moreover, the present invention relates to a soy sauce koji produced by any one of abovementioned processes and having a reduced Busho-shu.

Furthermore, the present invention relates to a process for producing a soy sauce having a reduced Busho-shu, wherein a soy sauce koji produced by any one of abovementioned processes is mixed with a salt water to produce a soy sauce moromi mash, followed by fermentation and aging.

The present invention also relates to a soy sauce produced by the abovementioned process and having a reduced Busho-shu.

According to the present invention, a soy sauce koji and a soy sauce having reduced Busho-shu can be reliably produced. Moreover, a soy sauce having an extremely high content of glutamic acid and an excellent aroma can be produced at a high nitrogen utilization rate.

### BRIEF DESCRIPTION OF THE DRAWINGS

FIG. 1 shows the results of isobutyric acid contents (ppm) in koji over time in the course of koji-making using Aspergillus sojae strain ATCC 46250, Aspergillus oryzae strain ATCC 22787, and a mixture of these two types of strains.

### BEST MODE FOR CARRYING OUT THE INVENTION

Hereafter, the present invention will be described in detail.

The present invention relates to a process for producing a soy sauce koji and a soy sauce having reduced Busho-shu. For the soy sauce koji, soybeans are used as a protein raw material and wheat is used as a starch raw material. The production thereof is carried out by mixing soaked and steam-cooked soybeans, roasted and milled wheat, and a seed koji, followed by koji-making. The present invention is characterized by using koji molds having different isobutyric acid productivities as a seed koji in the course of koji-making so that the isobutyric acid content in the soy sauce koji is reduced so as to reduce a Busho-shu in the koji.

Specifically, a koji mold belonging to the genus Aspergillus which produces a high concentration of isobutyric acid during koji-making (hereunder, also referred to as “koji mold having a high isobutyric acid productivity”) and a koji mold belonging to the genus Aspergillus which does not produce, or produces a low concentration of isobutyric acid (hereunder, also referred to as “koji mold having a low isobutyric acid productivity”) are used as a seed koji in the course of koji-making. Here, the term “koji mold having a high isobutyric acid productivity” refers to a koji mold which produces isobutyric acid at a high concentration to a degree that a Busho-shu is detectable from a soy sauce koji when produced using this koji mold. Specifically, it refers to a koji mold which produces isobutyric acid at a double amount or more, and more preferably a triple amount or more, after 24 or 30 hours from the start of koji-making, as compared with the amount of isobutyric acid produced after about 20 hours from the start of the koji-making. More specifically, it is a koji mold which produces 40 ppm or more of isobutyric acid within about 24 to 42 hours from the start of koji-making, for example, after 24 or 30 hours therefrom.

### Koji-Making Condition (A):

26 g of defatted soybeans is sprayed with 135 W/W % water. 28 g of wheat is roasted and milled, and the resultant is mixed with the thus obtained soybeans. The mixture is then put into a 2 liter Fernbach flask, followed by sterilization under pressure and heating at 121° C. for 50 minutes. The resultant product is cooled down to a room temperature, and inoculated with 100 mg of bran seed koji. The flask is cotton-plugged and then is incubated in a thermostatic chamber at a room temperature of 30° C. to start koji-making. After 16 hours, the Fernbach flask is shaken so as to remove the heat generated in the koji (mixing process called “Teire”), and then is transferred into a thermostatic chamber at a room temperature of 25° C. After 8 hours, the “Teire” is performed again shaken to remove the heat generated in the koji, and then is transferred into a thermostatic chamber at a room temperature of 20° C. The koji-making is performed for 42 hours in total to obtain a koji.

### Process for Preparing Bran Seed Koji:

20 g of bran is sprayed with 80 W/W % water. 5 g of the above product is put into a 150 ml conical flask, followed by sterilization under pressure and heating at 121° C. for 50 minutes. The resultant product is cooled down to a room temperature, and inoculated with 2 to 3 scoops of a platinum loop with a koji mold which has been previously pure-cultured and isolated. The flask is incubated in a thermostatic chamber at a temperature of 30° C. for 72 hours.

On the other hand, the term “koji mold having a low isobutyric acid productivity” refers to a koji mold which does not produce, or produces isobutyric acid at a low concentration to a degree that a Busho-shu is undetectable from a soy sauce koji when produced using this koji mold. Specifically, it refers to a koji mold which produces isobutyric acid at a reduced amount after 24 or 30 hours from the start of koji-making, as compared with the amount of isobutyric acid produced after about 20 hours from the start of the koji-making, or a koji mold which does not produce isobutyric acid at all in the course of koji-making. More specifically, it is a koji mold which produces 20 ppm or less of isobutyric acid within about 24 to 42 hours from the start of koji-making, for example, after 24 or 30 hours therefrom.

Koji molds having the abovementioned properties can be readily obtained by preparing koji molds belonging to the genus Aspergillus, followed by koji-making according to a normal koji-making condition, preferably the above koji-making condition (A), measuring the amount of isobutyric acid in the koji, and selecting a strain which produces a large or small amount of isobutyric acid.

Koji molds belonging to the genus Aspergillus to be prepared are not specifically limited, although Aspergillus oryzae or Aspergillus sojae is preferred considering that these molds are used for the production of soy sauce koji.

The isobutyric acid content in koji or soy sauce can be measured by using any publicly known method. For example, 25 g of soy sauce koji is added with 40 ml of saturated salt water, which is well shaken and left at a room temperature for 24 hours. Then, the resultant product is filtered with a filter paper. Thus obtained filtrate (soy sauce koji extract) is extracted with methyl acetate, and is subjected to the analysis by gas chromatography (GC) method without a concentration process. Moreover, soy sauce is directly extracted as it is with methyl acetate, and is subjected to the analysis by gas chromatography (GC) method without a concentration process (see “Analysis of Aroma Components by Gas Chromatography” edited and written by THE JAPAN SOY SAUCE INSPECTION INSTITUTE, Association of Experimental Method for Soy Sauce, issued on Mar. 1, 1985, pp. 177 to 179).

As to the koji mold having a high isobutyric acid productivity, for example, Aspergillus sojae strain, preferably Aspergillus sojae strain ATCC 46250 which has been confirmed to produce 60 ppm or more of isobutyric acid during koji-making when the koji-making is performed under the abovementioned condition (A), can be used. This strain ATCC 46250 is deposited to the American Type Culture Collection, and is readily available. Moreover, this Aspergillus sojae strain ATCC 46250 is capable of producing a highly digestible soy sauce koji having a high protease activity and a high glutamic acid content, which is thus particularly preferably used in the present invention.

Moreover, as to the koji mold having a low isobutyric acid productivity, for example, Aspergillus oryzae strain, preferably Aspergillus oryzae strain ATCC 22787 which has been confirmed to produce 10 ppm or less of isobutyric acid during koji-making when the koji-making is performed under the abovementioned condition (A), can be used. This strain ATCC 22787 is also deposited to the American Type Culture Collection, and is readily available.

In the present invention, a plurality of types of koji molds can be employed so long as a koji mold having a high isobutyric acid productivity and a koji mold having a low isobutyric acid productivity are used. For example, one type of koji mold having a high isobutyric acid productivity and one type of koji mold having a low isobutyric acid productivity may be employed. Two types or more of koji molds having high isobutyric acid productivities and one type of koji mold having a low isobutyric acid productivity may also be employed. Alternatively, one type of koji mold having a high isobutyric acid productivity and two types or more of koji molds having low isobutyric acid productivities may be employed.

The amounts of koji mold having a high isobutyric acid productivity and koji mold having a low isobutyric acid productivity to be used for koji-making are not specifically limited. For example, the koji mold having a high isobutyric acid productivity and the koji mold having a low isobutyric acid productivity are mixed at a ratio of 20 to 80:80 to 20, preferably 40 to 60:60 to 40, and more preferably 45 to 55: 55 to 45.

The above koji mold having a high isobutyric acid productivity and koji mold having a low isobutyric acid productivity are used in accordance with a normal process for producing a soy sauce koji. In a brief description, the seed koji as mentioned above may be inoculated in a normal raw material of koji, for example a raw material of soy sauce koji which is obtained by mixing water-sprayed and steam-cooked soybean raw material with roasted and milled wheat raw material, followed by koji-making (culturing) at about 25° C. to 35° C. for an appropriate period of time. At this time, the koji mold having a high isobutyric acid productivity and the koji mold having a low isobutyric acid productivity can be inoculated in a same raw material of soy sauce koji, either concurrently or after a fixed interval. Other koji-making conditions, such as the amount of koji mold to be used, the temperature, humidity, and time for culture, the mode of culture (such as continuous type or batch type), the aeration-ventilation condition, and the number of times and duration of stirring (Teire) are not specifically limited, and an appropriate and publicly known condition in the art can be selected.

The soy sauce koji obtained as mentioned above has a reduced content of isobutyric acid, which is thus a soy sauce koji having a reduced Busho-shu. According to the process of the present invention, the amount of isobutyric acid contained in a koji is reduced to about 50% or less, and preferably about 30% or less, as compared to a soy sauce koji obtained by a conventional production process. Moreover, a soy sauce koji obtained by the present invention is highly digestible, high in the glutamic acid content, and capable of producing a soy sauce having a high ratio (Glu/TN) of glutamic acid to the total nitrogen (TN).

Further, a soy sauce koji obtained by the present invention can be used for producing a soy sauce having a reduced Busho-shu. A soy sauce can be produced using a soy sauce koji produced as mentioned above, through a moromi mash fermentation process and a press-filtration process according to a usual method. Specifically, a soy sauce koji is incubated with an appropriate concentration of salt water at a normal ratio for incubation, followed by fermentation and aging for 3 to 6 months with appropriate stirring by a usual method, to obtain an aged moromi mash. Next, the aged moromi mash is wrapped in a nylon filter cloth and press-filtered by a squeezer to obtain a raw soy sauce. This raw soy sauce is subjected to pasteurization, clarification, and sediment-removal to obtain a soy sauce. There is no specific limitation in the types of lactic acid bacterium and yeast to be used for the moromi mash fermentation process, and any appropriate and publicly known ones in the art may be employed.

According to the present invention, for the production of a soy sauce koji, with use of a koji mold which produces a strong protease and provides a highly digestible koji, it is possible to avoid a risk in which a high concentration of a component for Busho-shu which is one of the unpleasant smells of soy sauce, namely isobutyric acid, accumulates in the koji during the koji-making, and to reliably obtain a soy sauce having a reduced Busho-shu. Moreover, according to the present invention, such a Busho-shu, which has been so far considered as unavoidable, can be reliably kept from being generated and accumulated during the koji-making, and the amount of isobutyric acid contained in the soy sauce is reduced to about 60% or less, for example, about 50%. Therefore, according to the present invention, a soy sauce having a reduced Busho-shu can be obtained. The process of the present invention enables to produce a soy sauce having a high glutamic acid content and an excellent aroma.

### EXAMPLES

The present invention is hereafter described in greater detail with reference to the following examples, although the technical scope of the present invention is not limited thereto.

### Example 1

### Process for Producing Soy Sauce Koji with Use of Mixed Seed Koji and Measurement of Isobutyric Acid Content

### (1) Use of Mixed Seed Koji of Aspergillus Sojae and Aspergillus Oryzae

26 g of defatted soybeans is sprayed with 135 W/W % water. 28 g of wheat is roasted and milled, and the resultant is mixed with the thus obtained soybeans. The mixture is then put into a 2 liter Fernbach flask, followed by sterilization under pressure and heating at 121° C. for 50 minutes. The resultant product was cooled down to a room temperature, and inoculated with 200 mg of mixed seed koji containing 100 mg of seed koji of Aspergillus sojae strain ATCC 46250 and 100 mg of seed koji of Aspergillus oryzae strain ATCC 22787. The flask was cotton-plugged and then was incubated in a thermostatic chamber at a room temperature of 30° C. to start koji-making. After 16 hours, the Fernbach flask was shaken so as to remove the heat generated in the koji (mixing process called “Teire”), and then was transferred into a thermostatic chamber at a room temperature of 25° C. After 8 hours, the “Teire” was performed again to remove the heat generated in the koji, and then was transferred into a thermostatic chamber at a room temperature of 20° C. The koji-making was performed for 42 hours in total to obtain a soy sauce koji of the mixed seed koji.

The seed koji used herein was prepared by the following manner. 20 g of bran was sprayed with 80 W/W % water. 5 g of the above product was put into a 150 ml conical flask, followed by sterilization under pressure and heating at 121° C. for 50 minutes. The resultant product was cooled down to a room temperature, and inoculated with 2 to 3 scoops of a platinum loop with a koji mold which had been previously pure-cultured and isolated. The flask was incubated in a thermostatic chamber at a temperature of 30° C. for 72 hours (hereunder, the same manner was performed in comparative example and control example).

### (2) Comparative Example

### Use of Seed Koji of Aspergillus Sojae Strain ATCC 46250

A soy sauce koji of comparative example was obtained in the exactly same manner as that of the above process for producing soy sauce koji (1), except for that “100 mg of seed koji of Aspergillus sojae strain ATCC 46250” was used instead of the “mixed seed koji containing 100 mg of seed koji of Aspergillus sojae strain ATCC 46250 and 100 mg of seed koji of Aspergillus oryzae strain ATCC 22787”.

### (3) Control Example

### Use of Seed Koji of Aspergillus Oryzae Strain ATCC 22787

A soy sauce koji of control example was obtained in the exactly same manner as that of the above process for producing soy sauce koji (1), except for that “100 mg of seed koji of Aspergillus oryzae strain ATCC 22787” was used instead of the “mixed seed koji containing 100 mg of seed koji of Aspergillus sojae strain ATCC 46250 and 100 mg of seed koji of Aspergillus oryzae strain ATCC 22787”.

### (4) Measurement of Isobutyric Acid Content

Regarding the abovementioned production examples for producing three types of soy sauce koji (1) to (3), the ups and downs of isobutyric acid contents in these koji were measured over time. The isobutyric acid content was measured by the following manner. 25 g of soy sauce koji was added with 40 ml of saturated salt water, which was well shaken and left at a room temperature for 24 hours. Then, the resultant product was filtered with a filter paper. Thus obtained filtrate (soy sauce koji extract) was extracted with methyl acetate, and was subjected to the analysis by gas chromatography (GC) method without a concentration process.

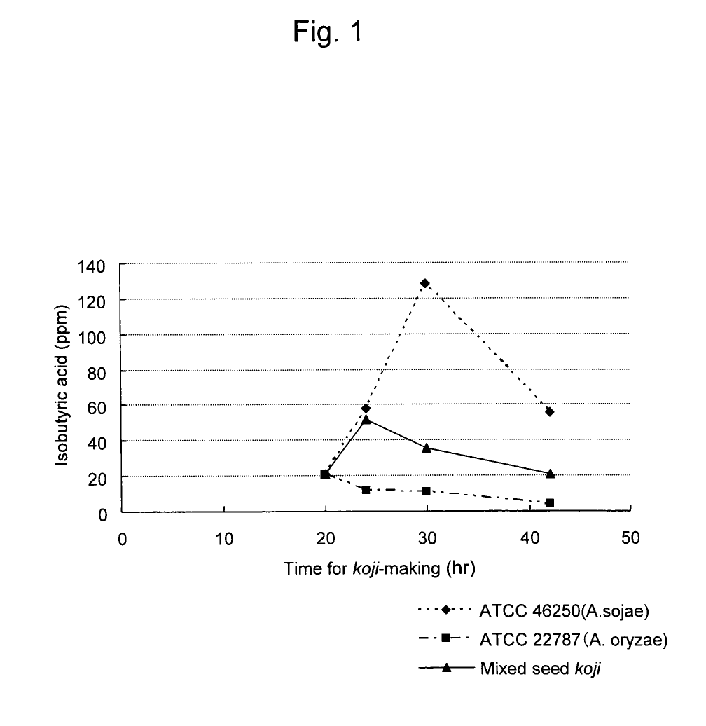

The results are shown in FIG. 1, wherein the X axis indicates the time (hours) elapsed from the start of koji-making, and the Y axis indicates the isobutyric acid content (ppm) in soy sauce koji.

The results in FIG. 1 show that Aspergillus sojae strain ATCC 46250 (comparative example) produced 40 ppm or more of isobutyric acid in koji after 24 hours from the start of koji-making, and accumulated 130 ppm thereof at maximum. Moreover, it is also found that isobutyric acid was contained at a high concentration of 60 ppm after 42 hours (FIG. 1, a broken line with rhomboids).

On the other hand, Aspergillus oryzae strain ATCC 22787 (control example) produced a low concentration of the component for Busho-shu (isobutyric acid) at 10 ppm after 24 hours from the start of koji-making, and showed approximately zero value after 42 hours, which indicates the disappearance thereof (FIG. 1, a two-dot chain line with squares).

Moreover, it is also found that the use of the mixed seed koji having Aspergillus sojae strain ATCC 46250 and Aspergillus oryzae strain ATCC 22787 mixed at equal amounts was able to reduce the isobutyric acid content to about one-third as compared to the single use of Aspergillus sojae strain ATCC 46250 (comparative example) (FIG. 1, a solid line with triangles).

### (5) Properties of Soy Sauce Koji

The moisture content, the pH, the amount of protease (U/g of koji), Glu/TN (ratio of glutamic acid to the total nitrogen content), and the digestibility of soy sauce koji of the mixed seed koji lot, the comparative example lot, and the control example lot that had been obtained by the above (1) to (3).

The pH and the protease amount (U/g of koji) were measured in accordance with the “Experimental Method for Soy Sauce” (THE JAPAN SOY SAUCE INSPECTION INSTITUTE).

The digestibility and Glu/TN were measured by the methods described below.

### (Method for Measuring Digestibility)

12 g of Koji was weighed, which was added with 62.5 ml of 12% salt water and 7.5 ml of toluene. The mixture was incubated to effect autodigestion at 37° C. for 7 days. The resultant product was filtered with a filter paper. The digestibility was calculated by dividing the nitrogen concentration in the filtrate by the total nitrogen concentration (in the filtrate and the residual material on the filter paper).

### (Method for Measuring Glu/TN)

The Glu/TN was calculated by dividing the glutamic acid concentration in the filtrate of the above koji digest liquid by the nitrogen concentration.

The results of the measurements carried out as mentioned above are shown in Table. 1 below.

TABLE 1
Analytical values of koji

| | | Moisture | | Protease | | Digestibility |
|---|---|---|---|---|---|---|
| Lot | Characteristic | content [%] | pH | [U/g of koji] | Glu/TN | [%] |
| Comparative | A. sojae | 44.2 | 7.23 | 261 | 0.67 | 82.7 |
| example lot | ATCC 46250 | | | | | |
| Control | A. oryzae | 44.8 | 6.95 | 139 | 0.55 | 78.7 |
| example lot | ATCC 22787 | | | | | |
| Mixed seed | Mixed seed | 45.7 | 7.19 | 248 | 0.61 | 84.2 |
| koji lot | koji mold | | | | | |

From the results of FIG. 1 and Table 1, it is found that the soy sauce koji of the comparative example lot using A. sojae alone (after 24 hours from the start of koji-making) has advantages of being very high in the protease activity, high in the ratio (Glu/TN) of glutamic acid (Glu) to the total nitrogen (TN), and high in the digestibility, while it conversely has a disadvantage of being very high in the concentration of isobutyric acid which is a causative component for Busho-shu.

Meanwhile, it is found that the soy sauce koji of the control example lot using A. oryzae alone (same as the above) is very low in the concentration of isobutyric acid which is a causative component for Busho-shu, while it has disadvantages of being low in both the protease activity and the ratio (Glu/TN) of glutamic acid (Glu) to the total nitrogen (TN).

On the other hand, it is found that the soy sauce koji of the mixed seed koji lot using a mixture of A. sojae and A. oryzae (same as the above) has characteristics of being high in all of the protease activity, the ratio (Glu/TN) of glutamic acid (Glu) to the total nitrogen (TN), and the digestibility, being low in the isobutyric acid content which is the most important factor, and thus having less Busho-shu, and that such a koji is therefore very useful for brewing a soy sauce.

### Example 2

### Process for Producing Soy Sauce

### (1) Production of Soy Sauce with Use of Soy Sauce Koji Obtained by Using Mixed Seed Koji

300 g of defatted soybeans is sprayed with 150 W/W % water. 300 g of wheat is roasted and milled, and the resultant is mixed with the thus obtained soybeans. The mixture is then subjected to sterilization under pressure and heating at 121° C. for 50 minutes. The resultant product was cooled down to a room temperature, and inoculated with 2 g of mixed seed koji containing 1 g of seed koji of Aspergillus sojae strain ATCC 46250 and 1 g of seed koji of Aspergillus oryzae strain ATCC 22787. The product was filled in a flat wooden koji cover having a length of 58 cm, a width of 30 cm, and a depth of 6 cm.

This cover was placed in a thermostatic chamber at a room temperature of 30° C. to start koji-making. The production of the seed koji was carried out in the same manner as that of the Example 1 (1).

After 16 hours, the product was agitated by hand (“Teire”) so as to remove the heat generated in the koji, and then was transferred into a thermostatic chamber at a room temperature of 25° C. After 8 hours, the “Teire” was performed again to remove the heat generated in the koji, and then was transferred into a thermostatic chamber at a room temperature of 20° C. The koji-making was performed for 30 hours in total to obtain a soy sauce koji of the mixed seed koji.

0.9 kg of thus obtained soy sauce koji was added with 1.4 liter of salt water. The mixture was placed in a small tank for incubation targeting a salt concentration of about 16%, followed by controlling of the moromi mash for 5 months in accordance with a normal process for producing a soy sauce koji, and thereby an aged soy sauce moromi mash was obtained.

In order to accelerate lactic acid fermentation and alcohol fermentation, a lactic acid bacterium (Tetragenococcus halophilus) isolated from the soy sauce moromi mash was added at 1×10⁵ c.f.u./g of moromi mash on 14th day of the incubation, and a yeast (Zygosaccahromyces rouxii) isolated from the soy sauce moromi mash was added at 1×10⁵ c.f.u./g of moromi mash on 35th day of the incubation.

This aged soy sauce moromi mash was press-filtered by a small squeezer to obtain a raw soy sauce. This soy sauce was pasteurized at 80° C. for 30 minutes and cooled down to a room temperature. The resultant soy sauce was left still for 2 days, and sediments were removed therefrom to obtain a clear soy sauce with less Busho-shu.

### (2) Comparative Example Lot

A soy sauce of comparative example lot was obtained in the exactly same manner as that of the above process for producing soy sauce in (1), except for that “1 g of seed koji of Aspergillus sojae strain ATCC 46250” was used instead of “2 g of the mixed seed koji containing 1 g of seed koji of Aspergillus sojae strain ATCC 46250 and 1 g of seed koji of Aspergillus oryzae strain ATCC 22787”.

### (3) Control Example Lot

A soy sauce of control example lot was obtained in the exactly same manner as that of the above process for producing soy sauce in (1), except for that “1 g of seed koji of Aspergillus oryzae strain ATCC 22787” was used instead of “2 g seed koji containing 1 g of seed koji of Aspergillus sojae strain ATCC 46250 and 1 g of seed koji of Aspergillus oryzae strain ATCC 22787”.

### (4) Component Analysis of Soy Sauce

Each soy sauce of the mixed seed koji lot, the comparative example lot, and the control example lot produced in the above (1) to (3) was subjected to component analysis of raw soy sauce, followed by sensory evaluation of flavor of pasteurized and aged soy sauce.

The component analysis of soy sauce, that is to say, the measurement of NaCl, TN (total nitrogen), Glu (glutamic acid), Glu/TN, RS (direct reducing sugar), Alc (alcohol), Lac (lactic acid), pH, and Col (color number) in a soy sauce was in accordance with the “Experimental Method for Soy Sauce” (THE JAPAN SOY SAUCE INSPECTION INSTITUTE). Greater color numbers mean lighter colors. The digestibility was obtained by the following manner. 10 g of moromi mash was filtered with a filter paper, and then calculation was performed by dividing the “nitrogen concentration in the filtrate” by the “total nitrogen amount in the filtrate and the residual material on the filter paper”. The isobutyric acid content was obtained by the following manner. The soy sauce was directly extracted as it was with methyl acetate, and was subjected to the analysis by gas chromatography (GC) method without a concentration process (see “Analysis of Aroma Components by Gas Chromatography” edited and written by THE JAPAN SOY SAUCE INSPECTION INSTITUTE, Association of Experimental Method for Soy Sauce, issued on Mar. 1, 1985, pp. 177 to 179).

The discrimination test and the preference test were performed by the method of three-point discrimination and preference test (referred to as triangle test) (see “Method of Sensory Evaluation” edited and written by THE JAPAN SOY SAUCE INSPECTION INSTITUTE, Association of Experimental Method for Soy Sauce, issued on Mar. 1, 1985, pp. 117 to 118). This method enables to perform both discrimination test and preference test in a single examination. First, a set consisting of three samples was prepared by selecting two samples from one type of sample, and one sample from another type of sample. In the discrimination test, one sample (different type from other two samples) was selected among three samples, followed by the preference test where comparison was performed between one selected sample and other two samples in terms of preference.

Table 2 shows the analytical values of the raw soy sauce components. Table 3 shows the results of the sensory evaluation. Table 4 shows the results of discrimination and preference tests.

TABLE 2
Analytical values of raw soy sauce components

| | | NaCl | TN | Glu | | RS | Alc | Lac | | | Digestibility |
|---|---|---|---|---|---|---|---|---|---|---|---|
| Lot | Characteristic | [%] | [%] | [%] | Glu/TN | [%] | [%] | [%] | pH | Col | [%] |
| Comparative | A. sojae | 16.25 | 1.81 | 1.10 | 0.61 | 2.72 | 3.85 | 0.79 | 4.88 | 31 | 81.4 |
| example lot | ATCC 46250 | | | | | | | | | | |
| Control | A. oryzae | 16.85 | 1.91 | 1.00 | 0.53 | 3.43 | 3.01 | 1.29 | 4.71 | 20 | 79.2 |
| example lot | ATCC 22787 | | | | | | | | | | |
| Mixed seed | Mixed koji mold of | 16.33 | 1.88 | 1.26 | 0.67 | 2.76 | 3.63 | 0.87 | 4.92 | 28 | 81.1 |
| koji lot | A. sojae and A. oryzae | | | | | | | | | | |

TABLE 3
Results of sensory evaluation

| | Charac- | Isobutyric | |
|---|---|---|---|
| Lot | teristic | acid (ppm) | Evaluation |
| Comparative | ATCC46250 | 20.4 | unpleasant smell |
| example lot | (A. sojae) | | |
| Control | ATCC22787 | 10.8 | Excellent |
| example lot | (A. oryzae) | | |
| Mixed seed koji lot | Mixed koji mold | 11.1 | Excellent |

TABLE 4
Results of discrimination and preference

| | Discrimination test | | | Preference test |
|---|---|---|---|---|
| | | Number of | | Number of preference |
| | Number of | correct | | among panelists who |
| Lot | panelists | answers | Judgment | gave correct answers |
| Comparative | 14 | 11 | * | 0 |
| example lot | | | | |
| Control | | | | 11 |
| example lot | | | | |
| Mixed seed | 17 | 5 | — | 3 |
| koji lot | | | | |
| Control | | | | 2 |
| example lot | | | | |

The mark * means a significance of 1%.

As shown in Table 2, it is found that the comparative example lot, the control example lot, and the mixed seed koji lot provided almost equivalently excellent soy sauce in terms of the quality.

Moreover, as shown in Table 3, it is found that, in the results of the sensory evaluation, Busho-shu was felt in the comparative example lot from which about 20 ppm of isobutyric acid concentration had been detected, while the aroma was excellent in both the control example lot and the mixed seed koji lot from which about 10 ppm of isobutyric acid concentration had been detected.

Further, as shown in Table 4, it is found that, in the discrimination test, the comparative example lot and the control example lot were discriminated at a significance of 1%, and the comparative example lot was prone to be disliked. On the other hand, it is found that the mixed seed koji lot and the control example lot were not discriminated.

From the above result, it is understood that, according to the present invention, even with use of a koji mold having a high isobutyric acid productivity, a soy sauce having less unpleasant smell can be obtained by koji-making in which another koji mold having a low isobutyric acid productivity is additionally mixed therewith.

All publications, patents, and patent applications cited herein are incorporated herein by reference in their entirety.

### INDUSTRIAL APPLICABILITY

According to the present invention, a soy sauce koji and a soy sauce having reduced Busho-shu can be reliably produced. Moreover, a soy sauce having a high digestibility of koji, and a high content of glutamic acid can be produced, and thus a soy sauce having excellent soy sauce components and an excellent aroma can be produced.

1. A process for producing a soy sauce koji having a reduced Busho-shu, wherein koji-making is performed by inoculating a seed koji mold belonging to the genus Aspergillus which produces a high concentration of isobutyric acid during the koji-making and a seed koji mold belonging to the genus Aspergillus which does not produce, or produces a low concentration of isobutyric acid during the koji-making, into a same raw material of soy sauce koji.

2. The process according to claim 1, wherein the koji mold belonging to the genus Aspergillus which produces a high concentration of isobutyric acid during koji-making is a koji mold which produces isobutyric acid at a double amount or more after 24 or 30 hours from the start of koji-making, as compared with the amount of isobutyric acid produced after 20 hours from the start of the koji-making.

3. The process according to claim 1, wherein the koji mold belonging to the genus Aspergillus which produces a high concentration of isobutyric acid during koji-making is a koji mold which produces 40 ppm or more of isobutyric acid after 24 or 30 hours from the start of the koji-making, when koji-making is performed under the following condition (A):
Koji-making condition (A):
26 g of defatted soybeans is sprayed with 135 W/W % water. 28 g of wheat is roasted and milled, and the resultant is mixed with the thus obtained soybeans. The mixture is then put into a 2 liter Fernbach flask, followed by sterilization under pressure and heating at 121° C. for 50 minutes; the resultant product is cooled down to a room temperature, and inoculated with 100 mg of bran seed koji; the flask is cotton-plugged and then is incubated in a thermostatic chamber at a room temperature of 30° C. to start koji-making; after 16 hours, the Fernbach flask is shaken so as to remove the heat generated in the koji (mixing process called “Teire”), and then is transferred into a thermostatic chamber at a room temperature of 25° C.;
after 8 hours, the “Teire” is performed again to remove the heat generated in the koji, and then is transferred into a thermostatic chamber at a room temperature of 20° C.; and the koji-making is performed for 42 hours in total to obtain a koji.

4. The process according to claim 1, wherein the koji mold belonging to the genus Aspergillus which produces a high concentration of isobutyric acid during koji-making is Aspergillus sojae.

5. The process according to claim 1, wherein the koji mold belonging to the genus Aspergillus which produces a high concentration of isobutyric acid during koji-making is Aspergillus sojae strain ATCC 46250.

6. The process according to claim 1, wherein the koji mold belonging to the genus Aspergillus which does not produce, or produces a low concentration of isobutyric acid during koji-making is a koji mold which produces isobutyric acid at a reduced amount, or no isobutyric acid at all, after 24 or 30 hours from the start of koji-making, as compared with the amount of isobutyric acid produced after 20 hours from the start of the koji-making.

7. The process according to claim 1, wherein the koji mold belonging to the genus Aspergillus which does not produce, or produces a low concentration of isobutyric acid during koji-making is a koji mold which produces 20 ppm or less of isobutyric acid after 24 or 30 hours from the start of the koji-making, when a koji-making is performed under said condition (A).

8. The process according to claim 1, wherein the koji mold belonging to the genus Aspergillus which does not produce, or produces a low concentration of isobutyric acid during koji-making is Aspergillus oryzae.

9. The process according to claim 8, wherein the koji mold belonging to the genus Aspergillus which does not produce, or produces a low concentration of isobutyric acid during koji-making is Aspergillus oryzae strain ATCC 22787.

10. A soy sauce koji produced by the process according to claim 1 and having a reduced Busho-shu.

11. A process for producing a soy sauce having a reduced Busho-shu, wherein a soy sauce koji produced by the process according to claim 1 is mixed with a salt water to produce a soy sauce moromi mash, followed by fermentation and aging.

12. A soy sauce produced by the process according to claim 11 and having a reduced Busho-shu.
